(19) United States
(12) Patent Application Publication
(10) Pub. No.: US 2019/0138912 A1
(43) Pub. Date: May 9, 2019

(54) DETERMINING INSIGHTS FROM DIFFERENT DATA SETS

(71) Applicant: Adobe Inc., San Jose, CA (US)

(72) Inventors: Kourosh Modarresi, Los Altos, CA (US); Jamie Mark Diner, Pittsburgh, PA (US)

(21) Appl. No.: 15/808,741

(22) Filed: Nov. 9, 2017

(51) Int. Cl. G06N 5/02; G06N 99/00

(52) U.S. Cl. CPC G06N 5/02; G06N 99/005

(57) ABSTRACT

Systems, methods, and non-transitory computer-readable media (systems) are disclosed for generating an analytics insight from a data set based on learning from a different data set. In particular, in one or more embodiments, the disclosed systems analyze a first data set to determine significant features related to an analytics metric. The disclosed systems determine a correlation between features of a second data set and the significant features of the first data set. Furthermore, in one or more embodiments, the disclosed systems utilize the correlation to generate an analytics insight, such as insights on segment of users. In one or more embodiments, the first data set and the second data set contain different features and/or different users and the second data set lacks data regarding the analytics metric.

### BACKGROUND

Network users access millions of websites daily for a variety of purposes. Network users access websites for purposes such as commerce, information, and entertainment. In fact, it is not uncommon for network users to conduct a large portion of their daily tasks (e.g., shopping, news, recipes, exercise) via various websites or applications. Additionally, users access networks to transfer files, submit search queries, upload pictures and other electronic media, send social network posts, or to utilize various “web-enabled” devices. Users utilize various network connections and servers to perform these tasks, in addition to countless other tasks.

In light of widespread and daily network usage, administrators and marketers generally perform data analytics in association with the data collected. Occasionally, the collected data reveals patterns associated with a particular type of user action performed in connection with a website, web page, or client application. For example, a pattern can comprise a correlation between characteristics and a particular type of user action performed in connection with a website or application. These patterns are important as they help marketers and administrators to focus their efforts and resources on users that are most likely to perform sought after user actions on a particular website or application (such as make a purchase).

Despite the utility of discovering patterns in the collected data, the amount of data a system may collect for even a single website or application may be unwieldy or too difficult to manage. The amount of data can be particularly problematic for websites or applications that receive thousands or millions of daily visitors or users. Discovering patterns in these large data sets is typically a complex and time consuming task. For example, in order to identify a pattern associated between the collected data and a particular type of action, a website administrator may need to run multiple data analyses. It may take days, if not weeks, for a website administrator to run and review the results of these data analyses in order to determine an actionable correlation.

Moreover, administrators and marketers may not always acquire the same type of data sets. Conventional data analytics procedures require repeating these time consuming data analyses for newly obtained information. This repetition of discovery using data analyses on data sets is time-wise and computationally expensive.

Thus, there are several disadvantages to current methods for data analytics.

### SUMMARY

This disclosure describes one or more embodiments that provide benefits and/or solve some or all of the foregoing (or other) problems with systems, computer-readable media, and methods that determine analytics insights for a data set using learning from another data set. For example, the systems, computer-readable media, and methods analyze a first data set to learn features or attributes that contribute to an analytics metric. The systems, computer-readable media, and methods then utilize the learning from the first data set to discover a correlation between features of a second analytics data set and the determined significant features of the first analytics data set. The systems, computer-readable media, and methods can discover the correlation between features of a second analytics data set and the determined significant features of the first analytics data set without performing a complete analysis of the second data set or even having data about the analytics metric in the second data set. In one or more embodiments, the disclosed systems, computer-readable media, and methods determine a significance of the features of the second analytics data set relative to the analytics metric. The systems, computer-readable media, and methods then use the determined significance of the features of the second data set to generate an analytics insight for the second data set relative to the analytics metric.

Additional features and advantages of one or more embodiments of the present disclosure will be set forth in the description which follows, and in part will be obvious from the description, or may be learned by the practice of such example embodiments.

### BRIEF DESCRIPTION OF THE DRAWINGS

The detailed description is described with reference to the accompanying drawings in which:

FIG. 1 illustrates a schematic diagram of an exemplary environment in which an analytics insight determination system can operate in accordance with one or more embodiments;

FIG. 2 illustrates an overview of a process of projecting learning from a data set onto a different data set in accordance with one or more embodiments;

FIG. 3 illustrates a process of projecting learning from a data set onto a different data set in accordance with one or more embodiments;

FIG. 4 illustrates a schematic diagram of an analytics insight determination system in accordance with one or more embodiments;

FIG. 5 illustrates a flowchart of a series of acts for generating an analytics insight from a data set using learning from another data set in accordance with one or more embodiments;

FIG. 6 illustrates a flowchart of a series of acts for generating an analytics insight from a data set using learning from another data set in accordance with one or more embodiments; and

FIG. 7 illustrates a block diagram of an exemplary computing device in accordance with one or more embodiments.

### DETAILED DESCRIPTION

This disclosure describes one or more embodiments of an analytics insight determination system that determines an analytics insight for an analytics data set using learning from another analytics data set. More specifically, in some embodiments, the analytics insight determination system performs an in-depth analysis of a first analytics data set to determine features from the first analytics data set that influence an analytics metric (i.e., determines significant features). The analytics insight determination system then determines a correlation between features of a second analytics data set and the determined significant features of the first analytics data set. Based on the correlation between the features of the second analytics data set and the determined significant features of the first analytics data set, the analytics insight determination system determines an analytics insight for the second analytics data set relative to the analytics metric.

More particularly, in one or more embodiments, the analytics insight determination system accesses a first analytics data set that includes a plurality of features or attributes. The analytics insight determination system then identifies an analytics metric (conversion event, click, download, impression, etc.) upon which to base an analysis of the first analytics data set. The analytics insight determination system then performs an in-depth analysis of the first analytics data set, using machine learning models, to determine or estimate the features of the first analytics data set that influence the identified analytics metric. In one or more embodiments, the analytics insight determination system determines features that statistically influence the identified analytics metric (i.e., significant features).

Then, the analytics insight determination system can access a second analytics data set that includes a plurality of features. In one or more embodiments, the second analytics data set does not include data for the identified analytics metric. Still further, in one or more embodiments the second analytics data set includes different features than the first analytics data set.

The analytics insight determination system determines a correlation between features of a second analytics data set and the determined significant features of the first analytics data set. For example, the analytics insight determination system extends or projects the features of the second analytics data set onto the significant features from the first analytics data set. The analytics insight determination system can further determine a significance of the features of the second analytics data set relative to the analytics metric. The analytics insight determination system can determine significance of the features of the second analytics data set relative to the analytics metric despite the second analytics data set lacking information regarding the analytics metric.

Based on the correlation between the features of the second analytics data set and the determined significant features of the first analytics data set, the analytics insight determination system can generate an analytics insight for the second analytics data set. For example, the analytics insight determination system can determine which users or segments of users are likely to perform or cause the analytics metric. In still further embodiments, the analytics insight determination system can determine significant features of the second analytics data set relative to the analytics metric. The analytics insight determination system can then target using having the determined significant features of the second analytics data set relative to the analytics metric.

As previously mentioned, the analytics insight determination system provides many advantages and benefits over conventional systems and methods by projecting learning from a first analytics data set onto a second analytics data set. For example, the disclosed analytics insight determination system is capable of learning significant features of the second data analytics from a first analytics data set even if the features of the second data analytics set are different from the features of the first analytics data set. Thus, the analytics insight determination system is flexible and can learn from data without restrictions on the second data analytics set (i.e., the second analytics data set can be an arbitrary data set).

Further, as another example, in many embodiments, the analytics insight determination system provides increased flexibility over known systems by being able to learn a significance of the features of an analytics data set relative to an analytics metric despite a lack of data in the analytics data set that allows for directly determining the significance. In other words, the analytics insight determination system can learn a significance of the features of an analytics data set relative to an analytics metric despite the analytics data set not having any data regarding the analytics metric. Thus, the analytics insight determination system is more robust than conventional analytics systems.

As a further benefit, the analytics insight determination system reduces memory needs and computational requirements over conventional systems. For example, the analytics insight determination system can determine a significance of the features of an analytics data set relative to the analytics metric without having to perform a full analysis of the data set. In particular by leveraging learning from another data set, the analytics insight determination system can generate an analytics insight faster than conventional methods while simultaneously using less computing power. Indeed, once a full analysis of a first data set has been performed to learn significant features, the analytics insight determination system can project this learning unto any number of other data sets.

The following terms are provided for reference. As used herein, the term “analytics data set” refers to an organized set of data. For example, an analytics data set can comprise data collected based on actions taken using computing devices that communicate over networks. In particular, the term “analytics data set” includes a collection of information that is composed of separate elements that can be used for analytical and statistical purposes by a computing device. The analytics data set can be represented in various formats including an array, matrix, digital file, database, table, and other data structures. For example, an analytics data set can include a grouping of information collected in relation to a website or native application. Specifically, an analytics data set can include a grouping of information such as features of a user, client device, etc. In one or more embodiments, an analytics data set is related to a particular dimension or category. For example, an analytics data set can comprise data for a specific region, group of users, website, time span, etc.

As used herein, the term “features” refers to data elements within an analytics data set. In particular, the term “features” includes informational elements that can be used for analytical and statistical purposes. Features can be represented in various formats including data points, rows, columns, vectors, metrics, numbers, texts, and other informational representations. Specifically, features can include information or data about user characteristics (e.g., gender, location, type, age, profile information), user actions (e.g., a user's session time, browser characteristics, conversion, download history, clicks, navigation paths, or purchasing history), and device characteristics (brand of device, operating system, browser used, GPS location information, etc.).

As used herein, the term “significant features” refers to features within an analytics data set that have an analytical or statistical importance. In particular, the term “significant features” includes features within an analytics data set that have a measurable analytical or statistical relationship with respect to an analytics metric. For example, significant features can include features of an analytics data set that have a measurable analytical or statistical relationship with an analytics metric that meets a predefined threshold. In additional embodiments, significant features can comprise the top number or percentage of features based on a measurable analytical or statistical relationship with an analytics metric. For instance, significant features can comprise the top 10 or top 50 percent of features that statistically affect an analytics metric. In one or more embodiments, significant features exclude features that do not measurably affect an analytics metric or have a measurable analytical or statistical relationship with an analytics metric that is below a predefined threshold.

As used herein, the term “analytics metric” refers to an informational element that represents a resulting behavior(s), event(s), or action(s). In particular, the term “analytics metric” includes information of a resulting behavior or event contained within an analytics data set. An analytics metric can be represented in various formats including data points, rows, columns, vectors, metrics, numbers, text, and other informational representations. For example, an analytics metric can include an informational representation of behaviors initiated by a website or application user. Specifically, an analytics metric can include a conversion rate, a conversion, a download, a click-thru rate, a navigation path of a website, a click, opening a message, subscribing to a product or service, or another metric.

As used herein, the term “weight” refers to a unit used for expressing the analytical or statistical relevance of a feature. In particular, the term “weight” can include a quantification of the relevance of features to an analytics metric. Weights can be represented as a data point, row, column, vector, metric, number, text, and other informational representations. For example, a weight can include a score assigned to features of an analytics data set in order to represent the features' correlation or influence on an analytics metric. Additionally, a weight can include the normalized significance of a feature and/or a significant feature (e.g., a weight can be number between 0 and 1).

As used herein the term “correlation” refers to a relationship between two or more items. For example, a correlation can comprise a mathematical expression (e.g., a formula) that explains how two or more variables (e.g., features) are related. In particular, a correlation can comprise a statistical relationship between variables. In one or more embodiments, a correlation is expressed by correlation coefficients (e.g., Pearson correlation coefficient) that express a degree of correlation between variables.

As used herein, the term “analytics insight” refers to information extracted from analytics data and can provide an understanding of a person or a thing that is determined by an analytics or statistical assessment. In particular, the term “analytics insight’ includes an understanding of an action based on analytics or statistical assessment of a data set and its features. For example, an analytics insight can include the probability of an action occurring based on features of an analytics data set. As another example, an analytics insight can include a determination of a segment of users likely to take a certain action (i.e., visiting a website, selecting a product, purchasing a product, downloading an application, or subscribing to a service). Alternatively, an analytics insight can comprise the identification of a segment of users likely not to take a certain action. Still further, an analytics insight can comprise a determination of significant features of a data set relative to an analytics metric. In one or more embodiments, a marketer can use an analytics insight to target a segment of users, perform an action such as modifying a website or a campaign, or sending messages or marketing materials.

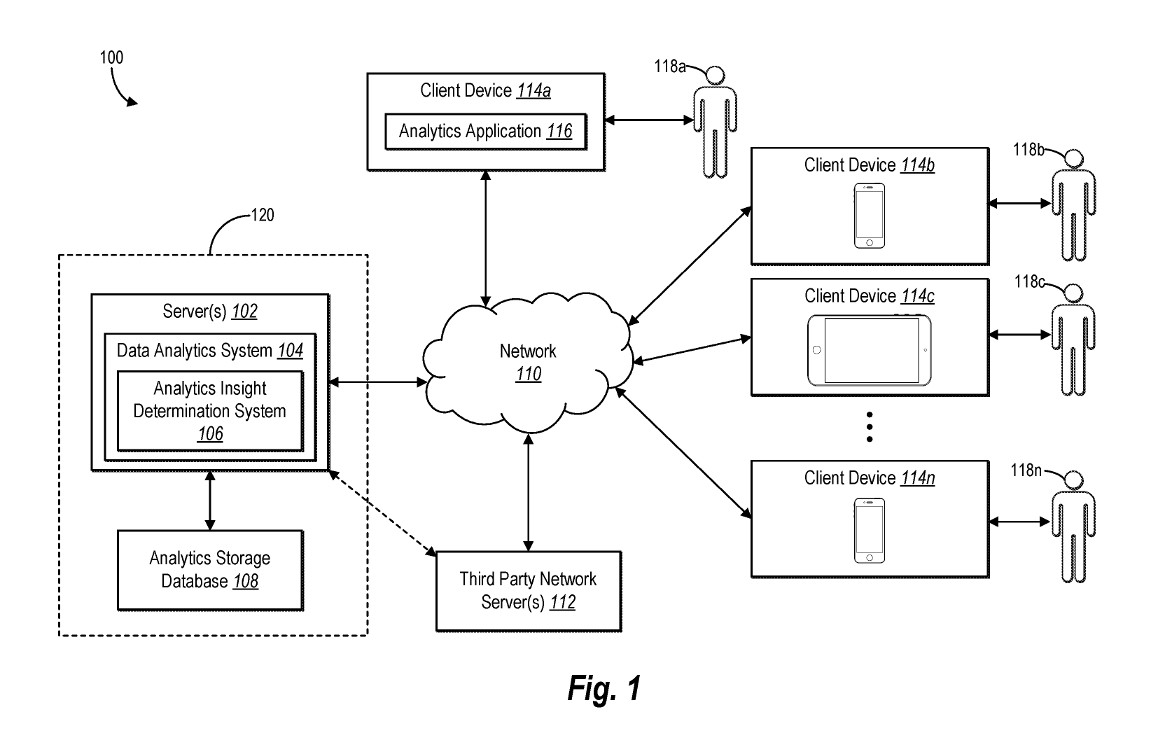

Turning now to the figures, FIG. 1 illustrates a schematic diagram of one embodiment of an exemplary environment 100 in which an analytics insight determination system 106 can operate. As illustrated in FIG. 1, the exemplary environment 100 may include users 118a-118n, client devices 114a-114n, a third-party network server 112 (e.g., a web server), and a network 110 (e.g., the Internet). As further illustrated in FIG. 1, the client devices 114a-114n can communicate with the third-party network server 112 and the server 102 through the network 110. Although FIG. 1 illustrates a particular arrangement of the users 118a-118n, the client devices 114a-114n, the network 110, the third-party network server 112, and the analytics insight determination system 106, various additional arrangements are possible. For example, the client devices 114a-114n may directly communicate with the third-party network server 112 (or server(s) 102), bypassing the network 110.

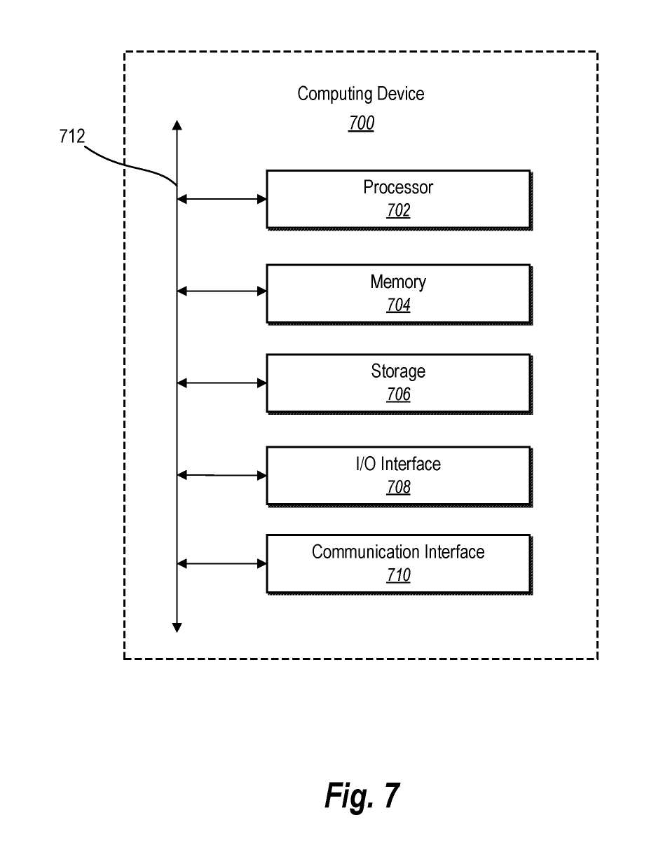

Moreover, the server(s) 102 and the analytics insight determination system 106 may manage and query data representative of some or all of the users 118a-118n. Additionally, the analytics insight determination system 106 may manage and query data representative of other users 118a-118n associated with the third-party network server 112. Furthermore, in one or more embodiments, the users 118a-118n can interact with the client-computing devices 114a-114n, respectively. Examples of client devices 114a-114n may include, but are not limited to, mobile devices (e.g., smartphones, tablets), laptops, desktops, or any other type of computing device. FIG. 7, and the associated description, provides additional information regarding computing devices, such as client devices.

As shown in FIG. 1, in one or more embodiments, the server(s) 102 can include a data analytics system 104 comprising at least a portion of the analytics insight determination system 106. The data analytics system 104 can track, manage, and/or query data representative of some or all of the users 118a-118n. Furthermore, the data analytics system 104 can include software and/or hardware tools that allow a third-party network server 112 and/or users 118a-118n of the client devices 114a-114n to manage and query data representative of some or all of the users 118a-118n.

Furthermore, as illustrated in FIG. 1, the data analytics system 104 can include the analytics insight determination system 106. The analytics insight determination system 106 can comprise an application running on the server(s) 102 or a portion of the analytics insight determination system 106 can be downloaded from the server(s) 102. For example, the analytics insight determination system 106 can include a web hosting application that allows the third-party network server 112 and/or the client devices 114a-114n to interact with data hosted at the server(s) 102.

Additionally, in one or more embodiments, the client devices 114a-114n of environment 100 can communicate with the third-party network server 112 through the network 110. In one or more embodiments, the network 110 may include the Internet or World Wide Web. The network 110, however, can include various types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks.

In one or more embodiments, the client devices 114a-114n may communicate with the third-party network server 112 for a variety of purposes. For example, the third-party network server 112 may be a web server, a file server, a server, a program server, an application store, etc. Thus, in one or more embodiments, the client devices 114a-114n communicate with the third-party network server 112 for purposes such as, but not limited to, requesting a web page, uploading a file, updating a profile, downloading a game, and so forth. For example, in one embodiment the third-party network server 112 may be a web server for an ecommerce business. In that example, a user 118a-118n may communicate with the web server by requesting web pages from the web server for display via a web browser operating on the client device 114a-114n.

In one embodiment, the digital analytics system 104 can track and store various user data related to interactions between the client devices 114a-114n and the third-party network server 112. For example, the digital analytics system 104 may track user data including, but not limited to, user actions (i.e., URL requests, link clicks, mouse hovers, text inputs, video views, button clicks, etc.), time data (i.e., when a link was clicked, how long a user stayed on a webpage, when an application was closed, etc.), path tracking data (i.e., what web pages a user visits during a given session, etc.), demographic data (i.e., an indicated age of a user, an indicated gender of a user, an indicated socioeconomic status of a user, etc.), geographic data (i.e., where a user is located, etc.), and transaction data (i.e., the types of purchases a user makes, etc.), as well as other types of data. For instance, in one embodiment, the third-party network server 112 may be a web server, and the client devices 114a-114n may communicate with the third-party network server 112 in order to request web page information so that a certain web page may be displayed to the user 118a-118n of client device 114a-114n via the client devices 114a-114n. In that case, the digital analytics system 104 may track the user action (i.e., requesting the web page data), the time the action was performed, the geographic information associated with the client devices 114a-114n (i.e., a geographic area associated with an IP address assigned to the client devices 114a-114n), and/or any demographic data that may be associated with the users 118a-118n.

The digital analytics system 104 can track and store user data in various ways. For example, in some instances, the third-party network server 112 may track user data. In one embodiment, the third-party network server 112 can track the user data and then report the tracked user data to an analytics server, such as the server 102 (i.e., via the dashed line illustrated in FIG. 1). In order to obtain the tracking data described above, the third-party network server 112 may utilize data stored on the client devices 114a-114n (i.e., a browser cookie), embed computer code (i.e., tracking pixels), initialize a session variable, access a user profile, or engage in any other type of tracking technique. Once the third-party network server 112 has tracked the user data, the third-party network server 112 may report the tracked user data to the server 102.

Alternatively or additionally, the server 102 may receive tracked user data directly from the client devices 114a-114n. For example, the third-party network server 112 may install software code (tracking pixels of JavaScript) in web pages or applications provided to the client devices 114a-114n that causes the client devices 114a-114n to report user data directly to the server 102.

As illustrated in FIG. 1, the server 102 may be communicatively coupled with an analytics database 108 (i.e. a central repository of data). In one or more embodiments, the analytics database 108 may store tracked user data. In one embodiment, the analytics database 108 may be separately maintained from the server 102. Alternatively, in one embodiment, the server 102 and the analytics database 108 may be combined into a single device or collection of devices (e.g., as demonstrated by the box 120). In at least one embodiment, the analytics database 108 may be a series of remote databases controlled by a central manager.

For example, in one or more embodiments, the analytics database 108 may utilize a distributed architecture, wherein the analytics database 108 includes multiple storage devices that are not all connected to a common processing unit, but rather are controlled by a database management system. For instance, in one or more embodiments, the multiple storage devices of the analytics database 108 are dispersed over a network. Stored data may be replicated, fragmented, or partitioned across the multiple storage devices. In at least one embodiment, in response to a data query, the database management system of the analytics database 108 may return only a random sampling of data in order to save on processing time and resources. Alternatively or additionally, in response to a data query, the database management system of the analytics database 108 may return a full data set.

Furthermore, as shown in FIG. 1, the environment 100 may include a client device 114a that operates an analytics application 116. In one or more embodiments, a user 118a may be a network administrator who queries analytics data from the server 102 via the client device 114a. In one embodiment, the server 102 may provide various graphical user interface controls and displays to the analytics application 116 at the client device 114a in order to help the user 118a perform data analysis. Additionally, the server 102 may receive and process requests from the analytics application 116, and provide analysis results based on the received requests.

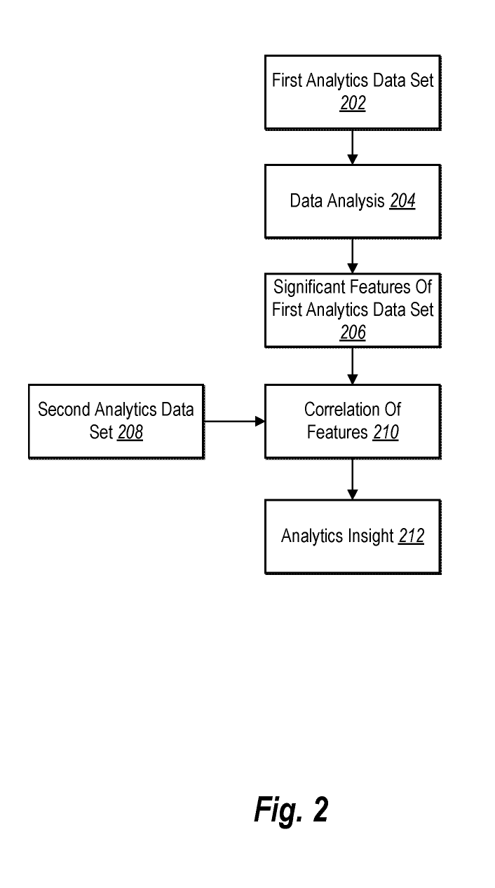

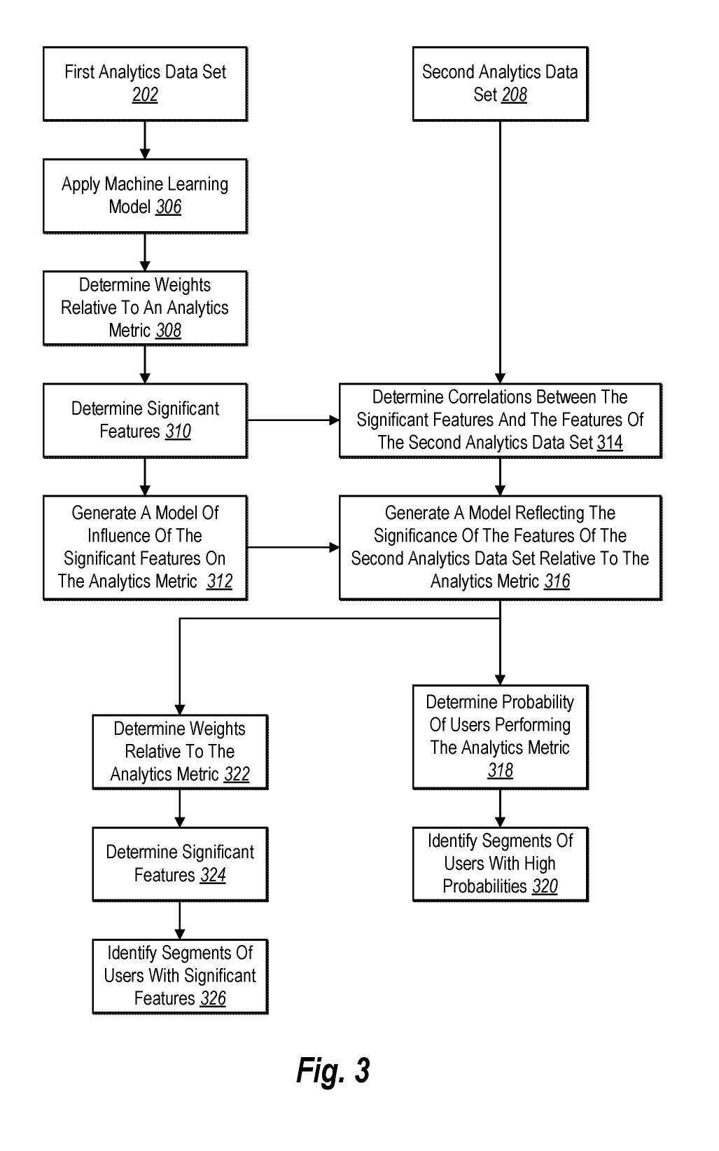

As mentioned above, the analytics insight determination system 106 can generate an analytics insight for an analytics data set using learning from another analytics data set. By way of example, in one or more embodiments, the analytics insight determination system 106 utilizes the server 102 to perform an in-depth analysis of a first analytics data set to determine significant features from the first analytics data set that relate to an analytics metric. For example, the analytics insight determination system 106 can access the first analytics data set at the analytics database 108. Additional detail regarding performing an in-depth analysis of a first analytics data set is provided below (e.g. in relation to FIGS. 2 and 3).

Upon performing an in-depth analysis of a first analytics data set, the analytics insight determination system 106 can then utilize the server(s) 102 to generate an analytic insight for a second analytics data set in relation to the identified analytics metric from the first analytics data set. In one or more embodiments, the analytics insight determination system 106 determines the analytics insight without performing an in-depth analysis of the second analytics data set. Specifically, the analytics insight determination system 106 can project the features of the second analytics data set onto the determined significant features of the first analytics data set to determine the analytics insight for the second analytics data set relative to an analytics metric.

As just mentioned, the analytics insight determination system 106 can generate an analytics insight from a second analytics data set using learning from another analytics data set. For example, FIG. 2 illustrates an overview of a sequence of acts that the analytics insight determination system 106 can perform to generate an analytics insight. The acts of FIG. 2 are also described relative to a simplified exemplary scenario for aid in illustrating one or more aspects of one or more embodiments. A more detailed description of the acts performed and the algorithms utilized by the analytics insight determination system 106 are discussed in reference to FIG. 3.

As shown by FIG. 2, the analytics insight determination system 106 accesses a first analytics data set 202. For example, the analytics insight determination system 106 can query the analytics storage database 108 to obtain the first analytics data set 202. Specifically, the user 118a can generate and send a request to the digital analytics system 104 to analyze the first analytics data set 202 with regard to an analytics metric. In response to the request, the analytics insight determination system 106 can query the analytics storage database 108 for the first analytics data set 202.

As a non-limiting example of a first analytics data set 202 for the exemplary scenario, the first analytics data set 202 contains data about website traffic and behavior specific to users in a first geographic region. Following the exemplary scenario, the first analytics data set 202 can be a data set containing data from a website of a company that sells a product. Specifically, the first analytics data set 202 can contain, for users in a first geographic region, features such as time per session, device size, browsing time on the website, age, and indications of conversion (i.e., user purchases of a product). The analytics metric in the exemplary scenario can comprise conversion or purchases of the product. It will be noted that the first analytics data set 202 includes data about the analytics metric (i.e., a feature indicating which users converted).

Because the first analytics data set 202 includes data about the analytics metric, the analytics insight determination system 106 can perform the data analysis 204 to identify relationships between other features in the first analytics data set 202 and the analytics metric. Thus, as part of the data analysis 204, the analytics insight determination system 106 can determine an amount by which the features in the first analytics data set 202 contribute to the analytics metric. For example, the analytics insight determination system 106 can use one or more machine learning models (such as those described in greater detail in relation to FIG. 3) to determine a weight for each feature relative to the analytics metric (e.g., a normalized amount each feature in the first analytics data set contributes to, drives, or affects the analytics metric). Following the exemplary scenario, the analytics insight determination system 106 can determine weights for the features of the first analytics data set 202 as follows: a 0.92 for the browsing time (e.g., time of the day) on the website, a 0.02 for the age, 0.05 for device size, and 0.70 (here, in this example, the weights are not normalized) for (average) time per session (whereas a higher value between 0 to 1 is considered to have a stronger influence on the analytics metric).

After performing the data analysis, the analytics insight determination system 106 may determine the significant features of the first analytics data set 206. In particular, the analytics insight determination system 106 can analyze the weights to identify features that significantly affect the analytics metric (i.e., identify the features with the largest weights). Following the exemplary scenario, the analytics insight determination system 106 can determine the browsing time on the website and time per session as the significant features of the first analytics data set 206 based on these two features having the largest weights.

The analytics insight determination system 106 also accesses a second analytics data set 208. For example, the analytics insight determination system 106 can query the analytics storage database 108 to obtain the second analytics data set 208. Specifically, the user 118a can generate and send a request to the digital analytics system 104 to analyze the second analytics data set 208 based on learning from the first analytics data set 202 with regard to the analytics metric. For example, the user 118a can desire to know if users (or which users) in a second geographic region will likely purchase the product from the website.

As a non-limiting example of a second analytics data set 208 for the exemplary scenario, the second analytics data set 208 contains data about users in the second geographic region, where the first geographic region differs from the second geographic region. Following the exemplary scenario, the second analytics data set 208 can be a data set containing data about users in a geographic region in which the website has not been marketed or deployed or where the product has not been offered. Specifically, the second analytics data set 208 can contain, for users in the second geographic region, features such as IP address, operating system, and types of websites most often visited.

It will be noted that the second analytics data set 208 lacks data about the analytics metric (i.e., a feature indicating conversion of the product). Furthermore, the features of the second analytics data set 208 can differ from the features of the first analytics data set 202. In one or more embodiments, there are no overlapping features between the features of the second analytics data set 208 and the features of the first analytics data set 202 as in the exemplary scenario. In alternative embodiments, the second analytics data set 208 and the first analytics data set 202 share a subset of features.

To learn from the first analytics data set 202, the analytics insight determination system 106 can determine a correlation 210 between features of the second analytics data set and the determined significant features of the first analytics data set. For example, the analytics insight determination system 106 can project the features of the second analytics data set onto the determined significant features of the first analytics data set to determine the correlation 210. Alternatively, the analytics insight determination system 106 can use a regression model to determine the correlation 210.

In one or more embodiments, the analytics insight determination system 106 can determine how strongly each feature of the second analytics data set 208 correlates to the significant features of the first analytics data set 206. For example, the analytics insight determination system 106 determines a strength of correlation between the significant features of the first analytics data set 206 and the features of the second analytics data set 208. In one or more embodiments, the strength of correlation comprises a correlation coefficient.

Moreover, the analytics insight determination system 106 utilizes the determined correlation to generate an analytics insight 212 for the second analytics data set 208. For example, the analytics insight determination system 106 can combine the strengths of correlation and the weights for the significant features of the first analytics data set 206 to determine a significance of the features of the second analytics data set 208 relative to the analytics metric. The analytics insight determination system 106 can then generate an analytics insight for the second analytics data set 208 relative to the analytics metric based on the determined significance of the features of the second analytics data set. For example, the analytics insight determination system 106 can identify a target segment (i.e., users most likely to perform or lead to the analytics metric) by identifying the users or segments of users with features having high significance relative to the analytics metric.

Continuing with the exemplary scenario, by identifying users or segments of users with features having high significance relative to the analytics metric, the analytics insight determination system 106 can identify users in New York most likely to convert or purchase the product on the website. Thus, the analytics insight determination system 106 can allow a marketer to target the identified segment of users in a marketing campaign.

Having provided an overview in relation to FIG. 2, more details regarding how the analytics insight determination system 106 determines significant features, determines correlations, determines a significance of the features, and generates analytic insights are provided in relation to FIG. 3.

As shown in FIG. 3, the analytics insight determination system 106 applies machine learning models 306 to determine weights 308 of the features of a first analytics data set 202. For example, the analytics insight determination system 106 can utilize a regularized random forest machine learning model (RRF), a guided regularized random forest machine learning model (GRRF), an adaptive boosting (AdaBoost) machine learning model, or another model to learn the significant features 310 of the first analytics data set 202. The analytics insight determination system 106 utilizes the machine learning model 306 to estimate the significance of each feature in the first analytics data set relative to an analytics metric. For example, the analytics insight determination system 106 can use a guided regularized random forest machine learning model to determine variable importance for the first analytics data set 202 (obtained through a random forest algorithm) and select as the significant features of the first analytics data set 310 the features with the largest variable importance.

More specifically, in one or more embodiments, the analytics insight determination system 106 can utilize a random forest algorithm to determine variable importance (an importance score) for the features of the first analytics data set 202 in relation to an analytics metric. In particular, in one or more embodiments, the analytics insight determination system 106 uses a random forest algorithm to draw n bootstrap samples from the first analytics data set 202. Furthermore, the analytics insight determination system 106 uses the random forest algorithm to grow an unpruned classification tree for each of the bootstrap samples. The analytics insight determination system 106 can, at each node of the classification tree, randomly sample predictors (i.e., features) and choose the best split from among those features (rather than choosing the best split among all predictors). The analytics insight determination system 106 predicts new data by aggregating the majority votes of the trees.

Moreover, the analytics insight determination system 106 can then use the random forest algorithm to produce an importance score (i.e., the importance of a feature due to the feature's relation to other features (e.g., the analytics metric)). The analytics insight determination system 106 can determine the importance score for each of the features of the first analytics data set by changing the out-of-bag data for each feature of the first analytics data set (without changing all the other features of the first analytics data set) and observing the change in prediction error. The analytics insight determination system 106 performs this tree by tree as the random forest is constructed.

Moreover, in one or more embodiments, the analytics insight determination system 106 can use a guided regularized random forest machine learning model to determine weights 308 for the first analytics data set in relation to the analytics metric. In particular, the analytics insight determination system 106 uses the determined importance scores for the features of the first analytics data set learned using the random forest algorithm. For example, the analytics insight determination system 106 uses the importance scores from the random forest algorithm to complement the information gain in a node. Gain(Fi) denotes the information gain of using a feature Fᵢ to split a tree node in the guided regularized random forest machine learning model. For example, to weight Gain(Fi), the analytics insight determination system 106 can use following equation:

gain_{G}(Fᵢ)=λᵢgain(Fᵢ)

Furthermore, in the equation above, λᵢ (or the weight 308 for feature Fᵢ) is calculated as:

$${λ}_{i} = 1 - γ + γ \frac{{Imp}_{i}}{{Imp}^{*}}$$

In the equation above, Impᵢ refers to the importance score of Fᵢ from the random forest algorithm and Imp* is the maximum importance score possible. Therefore,

$$\frac{{Imp}_{i}}{{Imp}^{*}}$$

is the normalized importance score and can be represented as a value from 0 to 1. Furthermore, the variable γ, in the equation above, controls the weight of the importance score from the random forest algorithm (also represented as a value from 0 to 1). As γ increases, the guided regularized random forest machine learning model penalizes features with smaller importance scores. Therefore, as γ approaches 1, the guided regularized random forest machine learning model will select less features (i.e., the features of the data set with the largest importance score).

Thus, the analytics insight determination system 106 determines weights 308 for the features of the first analytics data set. The weights 308 can be normalized to a numerical value between 0 and 1 that corresponds to what degree a feature correlates to the analytics metric. For example, a higher normalized weight 308 is equivalent to a higher correlation between the respective feature and the analytics metric 308.

The analytics insight determination system 106, in one or more embodiments, can determine significant features 310 relative to the analytics metric using the weights 308. In particular, the analytics insight determination system 106 identifies a subset of features from the features of the first analytics data set 202 as the significant features 310 of the first analytics data set 202 based on the weights 308. For example, the analytics insight determination system 106 can identify the top number of features having the largest associated weights 308, the top % of features having the largest associated weights 308, all features with an associated weight 308 above a threshold value (e.g., above 0.20), or the features whose weights 308 together account for a threshold contribution to the significance (e.g., F1 score), etc.

In one or more embodiments, the analytics insight determination system 106 can generate a model 312 reflecting a relationship between the significant features 310, the weights 308, and the analytics metric. As an example, the analytics insight determination system 106 can build a model 312 of the influence of the significant features 310 in leading to the analytics metric. In particular, the model 312 of the influence Ion an analytics metric of the total number (n) of determined significant features (SF) can be expressed as:

I=Σᵢ₌₁ⁿWᵢ*SFᵢ

where Wᵢ is the determined weight 308 for significant feature i.

Acts 306-312 and the algorithms presented above in relation to acts 306-312 can comprise the corresponding structure for performing a step for determining significant features of a first analytics data set relative to an analytics metric.

Having determined the significant features 310 of the first set 202 relative to the analytics metric, the analytics insight determination system 106 can determine correlations 314 between the features of the second analytics data set 208 and the significant features 310. For example, the analytics insight determination system 106 can perform a regression analysis. In particular, the analytics insight determination system 106 can use Pearson correlation or a regression model to project all the features of the second analytics data set 208 onto each significant feature of the first analytics data set 202. For example, the analytics insight determination system 106 can utilize a LASSO Regression model, a Ridge Regression model, an Elastic Net Regression model, a Regularized Random Forest model, or other regression model. The regularized random forest model, when used to determine the correlation 314 is used for regression instead of for classification as described above in relation to 306 (i.e., the result of the regularized random forest model is the average of the votes of the tress instead of the mode). When performing the regression analysis, the analytics insight determination system 106 uses a given significant feature 310 as the independent variable and the features of the second analytics data set 208 as the predictors.

The result of the regression analysis is correlations between each significant feature 310 and the features of the second analytics data set 208. For example, the analytics insight determination system 106 determines a correlation between a given significant feature SF and the total number (p) of features E in the second analytics data set 208 as follows:

(SF)ᵢ=Σⱼ₌₁^{p}αᵢⱼ*Eⱼ

where αⱼ is the determined correlation coefficient for feature j of the second analytics data set 208. For example, in one or more embodiments, αᵢⱼ is a Pearson correlation coefficient determined for a given feature determined from the regression analysis.

Given that total number of features p in the second analytics data set 208 can be large (tens, hundreds, or even thousands), the analytics insight determination system 106, can identify a subset of the features of the second analytics data set 208 which are most influential for a given significant feature. For example, the analytics insight determination system 106 can identify the top number of features based on the correlation coefficients. The analytics insight determination system 106 can then disregard, for each significant feature the non-influential features from the second analytics data set 208. One will appreciate that the second analytics data set 208 can disregard different features for each significant feature.

Acts and the algorithms presented in the paragraphs above and the description relative to box 314 of FIG. 3 can comprise the corresponding structure for performing a step for determining a correlation between features of a second analytics data set and the determined significant features of the first analytics data set.

In one or more embodiments, the analytics insight determination system 106 can generate a model 316 reflecting the significance of the features of the second analytics data set 208 relative to the analytics metric. As an example, the analytics insight determination system 106 can combine the correlations 314 and the weights 308 to generate the model 316. More particularly, as shown by FIG. 3, the analytics insight determination system 106 can inject the determined correlations 314 into the model 312 by substituting the correlation of each significant feature for the significant feature in the model 312. In so doing, the model 316 of the significance S of the features of the second analytics data set 208 relative to the analytics metric can be expressed as:

S=Σᵢ₌₁ⁿ(Wᵢ*Σⱼ₌₁^{p}αᵢⱼ*Eⱼ)

The output S of the model can comprise a significance score. As a simplistic example, given two significant feature SF₁ and SF₂, and the influential features E₁ and E₂ from the second analytics data set for the significant feature SF₁, and influential features E₁ and E₃ from the second analytics data set for the significant feature SF₂, the model 316 for the significance S would be:

S=W₁((α₁₁*E₁)+(α₁₂*E₂))+W₂((α₂₁*E₁)+(α₂₃*E₃))

Having modeled the significance of the features of the second analytics data set relative to the analytics metric, the analytics insight determination system 106 can generate an analytics insight for the second analytics data set relative to the analytics metric. For example, the analytics insight determination system 106 can determine the probability 318 of a user (or set of users) of performing one or more actions leading to the analytics metric. In particular, the analytics insight determination system 106 can plug the user or set of users features into the model 316 to determine a significance score for the user or set of users. The higher the significance score, the higher the probability 318 of the user(s) performing the analytic metric (e.g., conversion, click-thru rate, subscription, videos consumed). The analytics insight determination system 106 can then identify segments of users 320 with high probabilities 318 to target in a given campaign directed to the analytics metric.

Additionally, the analytics insight determination system 106 can utilize the information from the regression analysis/projection of the features of the second analytics data set onto the significant features of the first analytics data set to find the significant features of the second analytics data set 312. In particular, the analytics insight determination system 106 can utilize the determined correlation between the features of the second analytics data set and the significant features of the first analytics data set to select the features of the second analytics data set that have a higher correlation, with a specific significant feature of the first analytics data set, as the significant features of the second analytics data set, with respect to the specific significant feature of the first analytics data set.

Moreover, the analytics insight determination system 106 can order a data set in accordance to the significant features of the second analytics data set 314. In one or more embodiments, the analytics insight determination system 106 can order the data set in accordance to the significant features of the second analytics data set 314 by creating a data set (subset) that contains users from the second analytics data set 208 which exhibit the significant features of the second analytics data set. In one or more embodiments, the ordered data set in accordance to the significant features of the second analytics data set can be the generated actionable analytics insight 316.

In alternative embodiments, the analytics insight determination system 106 can determine projected weights 322 for the features of the second analytics data set 208 relative to the analytics metric. In particular, the analytics insight determination system 106 can simplify the model 316 using the distributive property and combining like terms. The combined weights and correlation coefficients generated in simplifying the model are the projected weights 322 for the features. For example, returning to the simplistic example of the model 316 above, the simplified model is:

S=(W₁α₁₁+W₂α₂₁)E₁+W₁α₁₂E₂+W₂α₂₃E₃

and the projected weight 322 for the feature E₁ is W₁α₁₁+W₂α₂₁. The weights 322 are considered projected in that they are learned from the first analytics data set rather than determined directly from the second analytics data set.

The analytics insight determination system 106 can further determine projected significant features 324 of the second analytics data set 208 relative to the analytics metric using the projected weights 322. In particular, the analytics insight determination system 106 identifies a subset of features, with respect to the specific significant feature of the first analytics data set, from the features of the second analytics data set 208 as the projected significant features 324 of the second analytics data set 208 based on the projected weights 322. For example, the analytics insight determination system 106 can identify the top number of features having the largest associated projected weights 322, the top % of features having the largest associated projected weights 322, all features with an associated projected weight 322 above a threshold value (e.g., above 0.20), or the features whose projected weights 322 together account for a threshold contribution to the significance (e.g., F1 score), etc. The significant features 324 of the second analytics data set 208 are considered projected in that they are learned from the first analytics data set rather than determined directly from the second analytics data set.

Having determined the features of the second analytics data set 208 that project to be significant relative to the analytics metric, the analytics insight determination system 106 can then identify segments of users 326 having the projected significant features to target in a given campaign directed to the analytics metric. This (segment) identification is based on using the specific significant feature(s) of the first analytics data set and the correlation of these significant features with the second analytics data set.

The process of determining correlations between the features of the second analytics data set 208 and the significant features 310 of the first analytics data set 202 was described above in relation to a regression of the features. In one or more embodiments, the analytics insight determination system 106 can perform a projection. For example, the analytics insight determination system 106 can project the features E onto the significant features SF of the first analytics data set. For example, the analytics insight determination system 106 can project the features of the second analytics data set 208 (any feature/vector Eⱼ) onto the significant features of the first analytics data set (any feature/vector SFᵢ) with the following equation:

$${P}_{{SF}_{i}}^{{E}_{j}} = \frac{{E}_{j} \cdot {SF}_{i}}{{‖ {SF}_{i} ‖}^{2}} * {SF}_{i}$$

The first part of the equation above,

$$\frac{{E}_{j} \cdot {SF}_{i}}{{‖ {SF}_{i} ‖}^{2}}$$

is the coefficient or the correlation of the Eⱼ and SFᵢ. Moreover, datasets (or segments) that are more correlated with SFᵢ are more likely to be considered significant as they might have a high correlation with an analytics metric (represented henceforth as Y) because SFᵢ is highly correlated with Y.

In one or more embodiments, the analytics insight determination system 106 can determine the total correlation of the features of the second analytics data set with each of the specific significant features, SFᵢ, from the first analytics data set using the following equation:

$$C = {\sum }_{j = 1}^{p} \frac{{E}_{j} \cdot {SF}_{i}}{{‖ {SF}_{i} ‖}^{2}}$$

Furthermore, the analytics insight determination system 106 can combine the correlations C with the weights W to generate a model 316 of the significance of the features of the second analytics data set relative to the analytics metric as follows:

$$S = {\sum }_{i = 1}^{n} {W}_{i} * {\sum }_{i = 1}^{p} \frac{{E}_{j} \cdot {SF}_{i}}{{‖ {SF}_{i} ‖}^{2}}$$

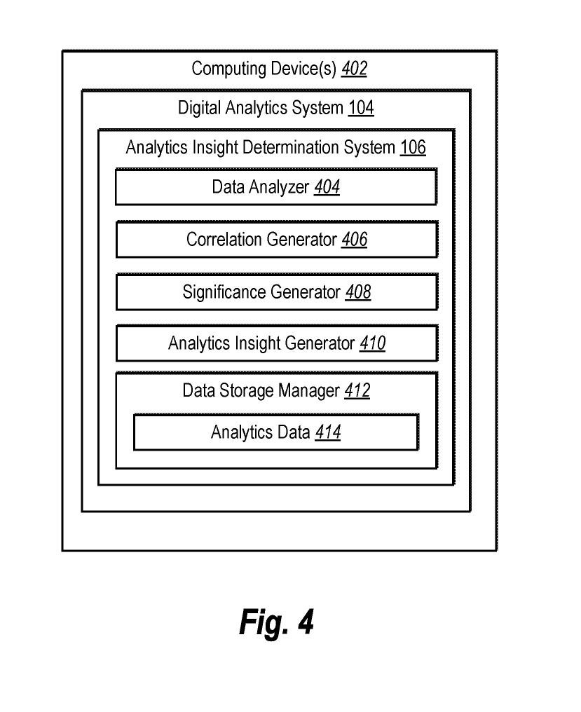

Now turning to FIG. 4, additional detail will be provided regarding components and capabilities of one example architecture of the analytics insight determination system 106. As shown in FIG. 4, the analytics insight determination system 106 may be implemented on a data analytics system 104 on a computing device 402. In particular, computing device 402 can implement the analytics insight determination system 106 with a data analyzer 404, a correlation generator 406, significance generator 408, an analytic insight generator 410 and a data storage manager 412 (that includes analytics data 414). Furthermore, the elements illustrated in FIG. 4 can be implemented on a computing device 402 where a computing device 402 comprises a server 102, a third-party network server 112, a network 110, or a client device 114a.

As just mentioned, and as illustrated in FIG. 4, the analytics insight determination system 106 includes a data analyzer 404. The data analyzer 404 can train, analyze, compute, and/or learn from one or more data sets. In particular, the data analyzer 404 can train a data set to generate a prediction model for the data set. More specifically, the data analyzer 404 can access, identify, generate, create, and/or determine significant features of a data set (i.e., the analytics data set) based on the data set's relation to a particular data set feature.

The data analyzer 404 can train/analyze various types of data sets. As discussed above, in one or more embodiments, the data analyzer 404 can analyze a data set (i.e. an analytics data set that can be represented in various formats including an array, matrix, digital file, database, table, and other data structures) to identify/determine significant features from that data set in relation to a specific data set feature.

The data analyzer 404, as discussed above in FIG. 3, can utilize a variety of machine learning models to train/analyze a data set. In particular, in one or more embodiments, the data analyzer 404 can utilize a regularized random forest machine learning model, a guided regularized random forest machine learning model, or an adaptive boosting machine learning model.

As illustrated in FIG. 4, the analytics insight determination system 106 also includes a correlation generator 406. The correlation generator 406 can project learning from one or more data sets onto another data set. In particular, the correlation generator 406 can generate a correlation between features of more than one data sets. In particular, the correlation generator 406 can utilize a projection or a regression model on a data set to generate a correlation between the data set and another data set. More specifically, the correlation generator 406 can access, identify, generate, create, and/or determine correlations between a data set (i.e., the second analytics data set) and another data set that has undergone an in-depth analysis with a machine learning model (i.e., a first analytics data set from the data analyzer 404) as described above. The correlation generator can do so without utilizing an in-depth analysis with a machine learning model.

The correlation generator 406 can, as discussed above in FIG. 3, utilize a variety regression models and/or projection to analyze a data set (i.e., the second analytics data set) to compute/determine a correlation between the data set or features of the data set and another data set that has undergone an in-depth analysis with a machine learning model (i.e., the data analyzer 404 analyzing a first analytics data set). In particular, in one or more embodiments, the correlation generator 406 can utilize a LASSO regression, a Ridge Regression, an Elastic Net Regression, and/or a regularized random forest. Furthermore, the correlation generator 406 can calculate a strength of correlation score for users or segments of users in a data set by combining a summation of correlations between the features of a data set and each significant feature of a data set analyzed by the data analyzer 404. The strength of correlation score can be determined for a data set of any size (i.e., a second analytics data set containing one user or multiple users).

As illustrated in FIG. 4, the analytics insight determination system 106 also includes a significance generator 408. In particular, the significance generator 408 can determine a significance of features of a data set relative to an analytics metric. The significance generator 408 can determine a significance of features without utilizing an in-depth analysis on the data set (i.e., by using the data analyzer 404). Furthermore, the significance generator 408 can determine a significance of features without having the ability to determine a direct significance (i.e., the data set lacks information on the analytics metric). In particular, the significance generator 408 can determine a significance of features by combining a determined correlation and the determined weights as described above.

As illustrated in FIG. 4, the analytics insight determination system 106 also includes an analytics insight generator 410. The analytics insight generator 410 can determine, predict, create, and/or generate insightful data on an analytics data set. In particular, the analytics insight generator 410 can generate analytics insights based on an analyzed analytics data set from the data analyzer 404, the correlation generator 406, and/or the significance generator 408. Specifically, the analytics insight generator 410 can determine, predict, create, and/or generate an insight from an analyzed analytics data set to reflect users or a subset of users from an analytics data set that likely contribute to an analytics metric based on a correlation determined by the correlation generator 406. Furthermore, the analytics insight generator 410 can determine, predict, create, and/or generate an insight from an analyzed analytics data set to reflect significant features of the analytics data set, from the feature significance analyzer 408, that likely contribute to an analytics metric as describe above.

As illustrated in FIG. 4, the analytics insight determination system 106 also includes the data storage manager 412. The data storage manager 412 maintains data for the analytics insight determination system 106. The data storage manager 412 can maintain data of any type, size, or kind as necessary to perform the functions of the analytics insight determination system 106. The data storage manager 412, as shown in FIG. 4, includes analytics data 414. The analytics data 414, in one or more embodiments, can be collected from the server(s) 102, the analytics database 108, the network 110, the third-party network server 112, and/or the client devices 114a-114n.

The analytics data 414 can include a plurality of data sets. Furthermore, the analytics data 414 includes analytics data sets utilized by a data analyzer 404, a correlation generator 406, a significance generator 408, and the analytics insight generator 410. Specifically, in one or more embodiments, the analytics data 414 can include data sets collected for tracked user data from websites and other applications. The analytics data 414 can include data sets that include data such as users, user features, and analytics metrics.

Moreover, the analytics data 414 includes data generated by the analytics insight generator 410. Specifically, analytics data 414 includes analytics data sets generated by the analytics insight generator 410 and utilized for targeting users from the analytics data sets in relation to an analytics metric.

Furthermore, analytics data 414 can include informational data. In particular, in one or more embodiments, the analytics data 414 includes a plurality of user features from an analytics data set and a plurality of analytics metrics from an analytics data set. Furthermore, the analytics data 414 includes user features and analytics metrics for users utilized by a data analyzer 404, a correlation generator 406, a significance generator 408 and the analytics insight generator 410.

Each of the components 402-414 of the analytics insight determination system 106 and their corresponding elements (as shown in FIG. 4) may be in communication with one another using any suitable communication technologies. It will be recognized that although components 402-414 and their corresponding elements are shown to be separate in FIG. 4, any of components 402-414 and their corresponding elements may be combined into fewer components, such as into a single facility or module, divided into more components, or configured into different components as may serve a particular embodiment.

The components 402-414 and their corresponding elements can comprise software, hardware, or both. For example, the components 402-414 and their corresponding elements can comprise one or more instructions stored on a computer-readable storage medium and executable by processors of one or more computing devices. When executed by the one or more processors, the computer-executable instructions of the analytics insight determination system 106 can cause a client device and/or a server device to perform the methods described herein. Alternatively, the components 402-414 and their corresponding elements can comprise hardware, such as a special purpose processing device to perform a certain function or group of functions. Additionally, the components 402-414 and their corresponding elements can comprise a combination of computer-executable instructions and hardware.

Furthermore, the components 402-414 of the analytics insight determination system 106 may, for example, be implemented as one or more stand-alone applications, as one or more modules of an application, as one or more plug-ins, as one or more library functions or functions that may be called by other applications, and/or as a cloud-computing model. Thus, the components 402-414 of the analytics insight determination system 106 may be implemented as a stand-alone application, such as a desktop or mobile application. Furthermore, the components 402-414 of the analytics insight determination system 106 may be implemented as one or more web-based applications hosted on a remote server. Alternatively or additionally, the components of the analytics insight determination system 106 may be implemented in a suit of mobile device applications or “apps.” To illustrate, the components of the analytics insight determination system 106 may be implemented in an application, including but not limited to ADOBE® TARGET®.

Researchers performed tests to validate that the analytics insight determination system 106 can accurately project learning between data sets in a manner that allows for accurate analytic insights. In this case, the normalized (proportional) conversion in each segment (the number of conversions in each segment divided by the total number of conversions in all three segments) is the metric. To validate this invention, it is important to test if the normalized conversion rate of each segment could be computed accurately using the models explained so far. To be able to validate the models, the true conversion rate for both data sets is necessary. To carry the validation process, in particular, the researchers took a single data set with 100 features and divided the single data set into two data sets of the same users and 50 different features for each data sets, the first set is the first analytics data set and the second part of the divided data set is the second analytics data set. The conversion for the second analytic data set is also available and is identical to that of the first analytics data set (first part of the divided data set) as the same set of data is divided into two sets of the same users but different features. This way, the available ground truth would make the validation process possible. The following table demonstrates the results of the analytics insight determination system 106 on three separate data segments. To determine the correlations between significant features in the first data set and the features in the second data set, and the to determine the analytics insights, one of four machine learning models i.e., RRF, Ridge Regression, LASSO, and Elastic Net were used. The table shows the predicted analytical insights by the analytics insight determination system (for each model) and compares it with the actual (ground truth) insights.

TABLE 1

| | | | Predicted | Predicted | |
|---|---|---|---|---|---|
| | Actual | Predicted | Conversion | Conversion | Predicted |
| | Conversion | Conversion | using Ridge | using | Conversion |
| | (ground | using RRF | Regression | LASSO | using Elastic |
| | truth) | model | model | model | Nets model |
| Segment 1 | 0.372 | 0.383 | 0.37 | 0.517 | 0.362 |
| Segment 2 | 0.62 | 0.611 | 0.622 | 0.466 | 0.61 |
| Segment 3 | 0.007 | 0.006 | 0.007 | 0.017 | 0.028 |

As shown in Table 1, RRF produced an average error of 0.009, Ridge Regression produced an average error of 0.002, and Elastic Nets produced an average error of 0.01. The evaluations show that the analytics insight determination system 106 is reliable at projecting learning and determining accurate analytic insights.

While the foregoing description has been provided mainly in a website or native application content, the analytics data sets can be data sets comprising other types of data (i.e., not data on users, user features, and user actions). In particular, the analytics insight determination system 106 can utilize a first analytics data set of various data types. For example, the analytics data sets can be comprised of weather data in terms of time. In one or more embodiments, the first analytics data set can include data (features) such as temperature, humidity, and whether there was rain (the analytics metric). Furthermore, the second data analytics data set can include data such as altitude, location, and terrain information. The analytics insight determination system 106 can utilize a machine learning model to perform an in-depth analysis on the first analytics data set in relation to the analytics metric (whether there was rain) to determine the significant features of the first analytics data set. Moreover, the analytics insight determination system 106, as discussed above, can project the features of the second analytics data set (i.e., the altitude, location, and terrain information) onto the significant features of the first analytics data set 206 to determine a correlation between features of a second analytics data set and the determined significant features of the first analytics data set. Additionally, using the correlation, the analytics insight determination system 106 can generate an analytics insight. In one or more embodiments, the analytics insight can comprise a subset of times from the second analytics data set where there is a likelihood of rain.

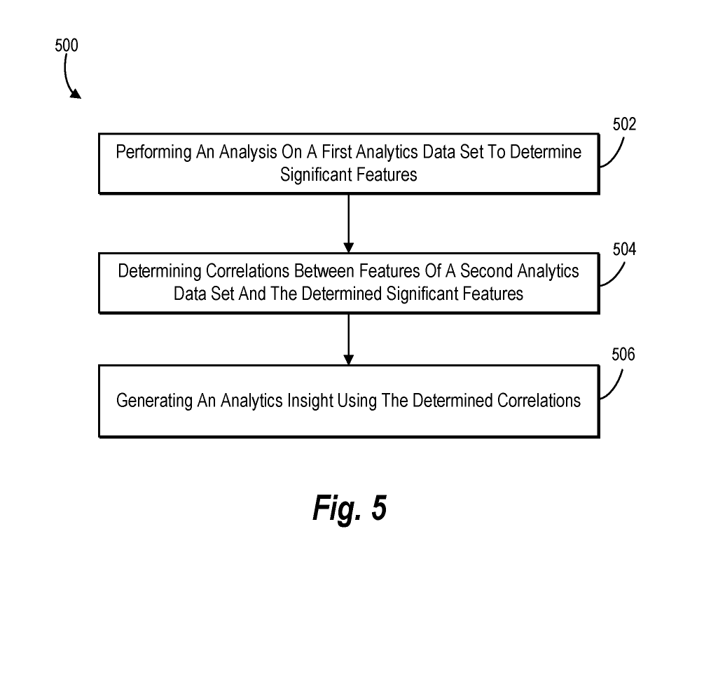

FIGS. 1-4, the corresponding text, and the examples, provide a number of different systems and devices that allows a system to generate an analytical insight for an analytics metric from one or more analytics data sets without performing an in-depth analysis of the one or more analytics data sets. In addition to the foregoing, embodiments can also be described in terms of a series of acts for accomplishing a particular result. For example, FIG. 5 illustrates a flowchart of a series of acts 500 for projecting learning from a data set onto a different data set in accordance with one or more embodiments. While FIG. 5 illustrates acts according to one embodiment, alternative embodiments may omit, add to, reorder, and/or modify any of the acts shown in FIG. 5. The acts of FIG. 5 can be performed as part of a method. Alternatively, a non-transitory computer readable medium can comprise instructions, that when executed by one or more processors, cause a computing device to perform the acts of FIG. 5. In still further embodiments, a system can perform the acts of FIG. 5.

As illustrated in FIG. 5, the series of acts 500 includes an act 502 of performing an analysis on a first analytics data set to determine significant features of the first analytics data set. In particular, the act 502 can include performing an analysis on a first analytics data set associated with a first set of users to determine significant features of the first analytics data set relative to an analytics metric. For example, the act 502 can involve utilizing one or more of a regularized random forest machine learning model, a guided regularized random forest machine learning model, or an adaptive boosting machine learning model.

As illustrated in FIG. 5, the series of acts 500 includes an act 504 of determining correlations between features of a second analytics data set and the determined significant features of the first analytics data set. For example, the act 504 can involve projecting the features of the second analytics data set onto the determined significant features of the first analytics data set. Act 504 can involve using a projection algorithm or a regression model to determine a correlation coefficient for the features of the second analytics data set relative to the significant features.

Additionally, in one or more embodiments, the second analytics data set is associated with a second set of users and does not include data for the analytics metric. In one or more embodiments, the first set of users are different from the second set of users. Additionally, in one or more embodiments, features of the first analytics data set are different from features of the second data set.

As illustrated in FIG. 5, the series of acts 500 includes an act 506 of generating an analytics insight using the determined correlations. In particular, the act 506 can include generating an analytics insight using the determined correlations between the features of the second analytics data set and the determined significant features of the first analytics data set. In addition, the act 506 can also include generating the analytics insight by identifying a subset of users from the second set of users likely to perform one or more actions associated with the analytics metric. For example, act 506 can involve identifying one or more segments with users having features that strongly correlate with the significant features. Alternatively, act 506 can involve identifying one or more segments with the long coefficient vectors determined by a regression algorithm.

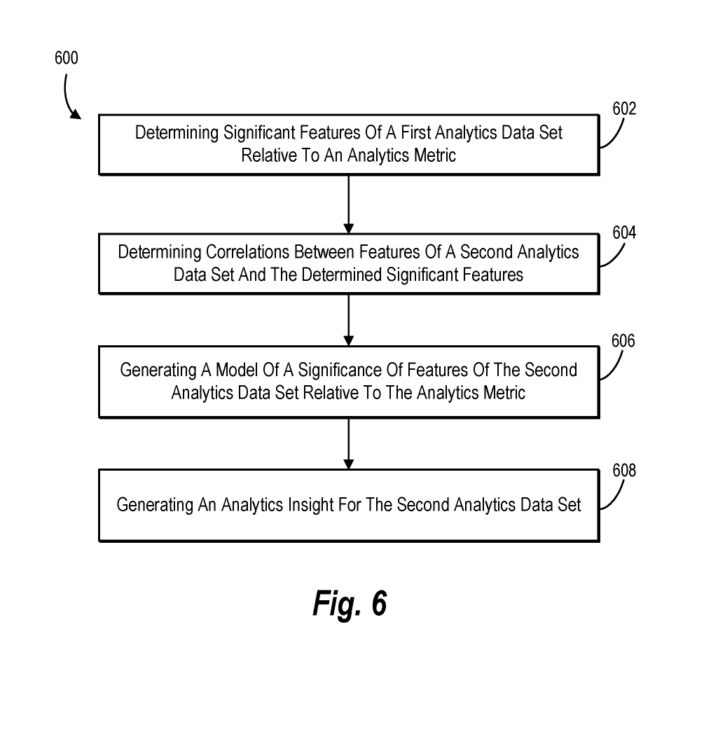

Turning now to FIG. 6, additional detail will be provided regarding a flowchart of a series of acts 600 for projecting learning from a data set onto a different data set in accordance with one or more embodiments. While FIG. 6 illustrates acts according to one embodiment, alternative embodiments may omit, add to, reorder, and/or modify any of the acts shown in FIG. 6. The acts of FIG. 6 can be performed as part of a method. Alternatively, a non-transitory computer readable medium can comprise instructions, that when executed by one or more processors, cause a computing device to perform the acts of FIG. 6. In still further embodiments, a system can perform the acts of FIG. 6.

As illustrated in FIG. 6, the series of acts 600 includes an act 602 of determining significant features of the first analytics data set. In particular, the act 602 can include determining significant features of a first analytics data set relative to an analytics metric. For example, act 602 can involve utilizing a machine learning model to determine weights for features of the first analytics data. Determining the weights can comprise determining an influence of the features on the analytics metric. Act 602 can involve utilizing one or more of a regularized random forest machine learning model, a guided regularized random forest machine learning model, or an adaptive boosting machine learning model to learn the weights of the features. Act 605 can involve identifying the features with the largest weights as the significant features.

As illustrated in FIG. 6, the series of acts 600 also includes an act 604 of determining correlations between features of the second analytics data set and the determined significant features of the first analytics data set. In one or more embodiments, the second analytics data set is associated with a second set of users and does not include data for the analytics metric. In one or more embodiments, the first set of users are different from the second set of users. Additionally, in one or more embodiments, features of the first analytics data set are different from features of the second data set.

In particular, the act 604 can include determining correlations between features of the second analytics data set and the determined significant features of the first analytics data set by projecting features of the second analytics data set onto the determined significant features of the first analytics data set. Act 604 can include projecting the features of the second analytics data set onto the determined significant features of the first analytics data set utilizing one or more of a Ridge Regression, an Elastic Net Regression, or a regression regularized random forest.

As illustrated in FIG. 6, the series of acts 600 can also include an act 606 of generating a model of a significance of the features of the second analytics data set relative to the analytics metric. In particular, the act 606 can include generating a model of a significance of the features of the second analytics data set relative to the analytics metric by combining the determined correlations and the determined weights for features of the first analytics data set relative to the analytic metric.

The series of acts can also involve generating a model reflecting an influence of the determined significant features on the analytics metric. In such cases, act 606 can involve substituting the correlations between the features of the second analytics data set and each significant feature for the significant features in the model reflecting the influence of the determined significant features on the analytics metric.

Alternatively, act 606 can involve multiplying each summation of correlation by the weight for the individual significant feature of the first analytics data set that was used in the respective summation. Moreover, each of the summations of correlations are combined to generate the strength of correlation score for users or segments (i.e., for the second analytics data set) in relation to an analytics metric.

As illustrated in FIG. 6, the series of acts 600 can also include an act 608 of generating an analytics insight for the second analytics data set. In particular, the act 608 can include generating an analytics insight for the second analytics data set relative to the analytics metric based on a determined significance of the features of the second analytics data set. Additionally, the act 608 can include generating the analytics insight by identifying a subset of users from the second set of users based on the determined significance of the features of the second analytics data set. For example, act 608 can involve identifying the segment of users from the second analytics data set with the largest strength of correlation score or the longest coefficient vector.

Still further, act 608 can involve determining probabilities of users of performing one or more actions leading to the analytics metric and identifying segments of users with high probabilities to target in a campaign directed to the analytics metric. Still further, act 608 can involve generating projected weights indicating a projected influence of the features of the second analytics data set on the analytics metric and determine projected significant features of the second analytics data set relative to the analytics metric using the projected weights.

The term “digital environment,” as used herein, generally refers to an environment implemented, for example, as a stand-alone application (e.g., a personal computer or mobile application running on a computing device), as an element of an application, as a plug-in for an application, as a library function or functions, as a computing device, and/or as a cloud-computing system.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 7 illustrates a block diagram of an exemplary computing device 700 that may be configured to perform one or more of the processes described above. One will appreciate that one or more computing devices, such as the computing device 700 may represent the computing devices described above (e.g., the server(s) 102, the client devices 114a-114n, the third-party network server 112). In one or more embodiments, the computing device 700 may be a mobile device (e.g., a mobile telephone, a smartphone, a PDA, a tablet, a laptop, a camera, a tracker, a watch, a wearable device, etc.). In some embodiments, the computing device 700 may be a non-mobile device (e.g., a desktop computer or another type of client device). Further, the computing device 700 may be a server device that includes cloud-based processing and storage capabilities.

As shown in FIG. 7, the computing device 700 can include one or more processor(s) 702, memory 704, a storage device 706, input/output (“I/O”) interfaces 708, and a communication interface 710, which may be communicatively coupled by way of a communication infrastructure (e.g., bus 712). While the computing device 700 is shown in FIG. 7, the components illustrated in FIG. 7 are not intended to be limiting. Additional or alternative components may be used in other embodiments. Furthermore, in certain embodiments, the computing device 700 includes fewer components than those shown in FIG. 7. Components of the computing device 700 shown in FIG. 7 will now be described in additional detail.

In particular embodiments, the processor(s) 702 includes hardware for executing instructions, such as those making up a computer program. As an example, and not by way of limitation, to execute instructions, the processor(s) 702 may retrieve (or fetch) the instructions from an internal register, an internal cache, memory 704, or a storage device 706 and decode and execute them.

The computing device 700 includes memory 704, which is coupled to the processor(s) 702. The memory 704 may be used for storing data, metadata, and programs for execution by the processor(s). The memory 704 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 704 may be internal or distributed memory.

The computing device 700 includes a storage device 706 includes storage for storing data or instructions. As an example, and not by way of limitation, the storage device 706 can include a non-transitory storage medium described above. The storage device 706 may include a hard disk drive (HDD), flash memory, a Universal Serial Bus (USB) drive or a combination these or other storage devices.

As shown, the computing device 700 includes one or more I/O interfaces 708, which are provided to allow a user to provide input to (such as user strokes), receive output from, and otherwise transfer data to and from the computing device 700. These I/O interfaces 708 may include a mouse, keypad or a keyboard, a touch screen, camera, optical scanner, network interface, modem, other known I/O devices or a combination of such I/O interfaces 708. The touch screen may be activated with a stylus or a finger.

The I/O interfaces 708 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 708 are configured to provide graphical data to a display for presentation to a user. The graphical data may be representative of one or more graphical user interfaces and/or any other graphical content as may serve a particular implementation.

The computing device 700 can further include a communication interface 710. The communication interface 710 can include hardware, software, or both. The communication interface 710 provides one or more interfaces for communication (such as, for example, packet-based communication) between the computing device and one or more other computing devices or one or more networks. As an example, and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI. The computing device 700 can further include a bus 712. The bus 712 can include hardware, software, or both that connects components of computing device 700 to each other.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. In a digital medium environment for collecting and analyzing analytics data, a method of projecting learning from a data set onto a different data set comprising:
performing a step for determining significant features of a first analytics data set relative to an analytics metric;
performing a step for determining correlations between features of a second analytics data set and the determined significant features of the first analytics data set; and
generating an analytics insight using the determined correlations between the features of the second analytics data set and the determined significant features of the first analytics data set.

2. The method of claim 1, wherein generating the analytics insight comprises identifying a subset of users from a second set of users from the second analytics data set likely to perform one or more actions associated with the analytics metric.

3. The method of claim 1, wherein performing the step for determining the correlations between the features of the second analytics data set and the determined significant features of the first analytics data set comprises generating correlation coefficients for the features of the second analytics data set using a regression analysis.

4. The method of claim 3, wherein performing the step for determining the correlations between the features of the second analytics data set and the determined significant features of the first analytics data set comprises utilizing a regularized random forest to project the features of the second analytics data set onto the significant features of the first analytics data set.

5. The method of claim 1, wherein performing the step for determining the correlation between features of the second analytics data set and the determined significant features of the first analytics data set requires less computational resources than performing the step for determining significant features of the first analytics data set relative to the analytics metric.

6. The method of claim 1, wherein performing the step for determining the significant features of the first analytics data set relative to the analytics metric comprises utilizing a guided regularized random forest machine learning model to determine the significant features of the first analytics data set.

7. A non-transitory computer readable medium storing thereon instructions for projecting learning from a data set onto a different data set, wherein the instructions, when executed by at least one processor, cause a computer system to:
perform an analysis on a first analytics data set associated with a first set of users to determine significant features of the first analytics data set relative to an analytics metric;
determine correlations between features of a second analytics data set and the determined significant features of the first analytics data set, the second analytics data set associated with a second set of users; and
generate an analytics insight using the determined correlation between the features of the second analytics data set and the determined significant features of the first analytics data set.

8. The non-transitory computer readable medium of claim 7, wherein the instructions, when executed by the at least one processor, cause the computer system to perform the analysis on the first analytics data set associated with the first set of users to determine the significant features of the first analytics data set relative to the analytics metric by utilizing one or more of:
a regularized random forest machine learning model;
a guided regularized random forest machine learning model; or
an adaptive boosting machine learning model.

9. The non-transitory computer readable medium of claim 7, wherein determining the correlation between the features of the second analytics data set and the determined significant features of the first analytics data set comprises utilizing a regression model.

10. The non-transitory computer readable medium of claim 7, wherein the second analytics data set does not include data for the analytics metric.

11. The non-transitory computer readable medium of claim 7, wherein features of the first analytics data set are different from features of the second analytics data set.

12. The non-transitory computer readable medium of claim 7, wherein instructions, when executed by the at least one processor, cause the computer system to generate the analytics insight by identifying a subset of users from the second set of users likely to perform one or more actions associated with the analytics metric.

13. A system for projecting learning from a data set onto a different data set comprising:
memory comprising:
a first analytics data set associated with a first set of users, and
a second analytics data set associated with a second set of users;
at least one processor; and
at least one non-transitory computer-readable storage medium storing instructions thereon that, when executed by the at least one processor, cause the system to:
perform an analysis on the first analytics data set to determine significant features of the first analytics data set relative to an analytics metric utilizing a machine learning model to determine weights for features of the first analytics data set, the weights indicating an influence of the features of the first analytics data set on the analytics metric;
determine correlations between features of the second analytics data set and the determined significant features of the first analytics data set by projecting features of the second analytics data set onto the determined significant features of the first analytics data set;
generate a model of a significance of the features of the second analytics data set relative to the analytics metric by combining the determined correlations and the determined weights; and
generate an analytics insight for the second analytics data set relative to the analytics metric based on the generated model of the significance of the features of the second analytics data set relative to the analytics metric.

14. The system of claim 13, wherein the instructions, when executed by the at least one processor, cause the system to perform the analysis on the first analytics data set to determine the significant features of the first analytics data set relative to the analytics metric utilizing one or more of:
a regularized random forest machine learning model;
a guided regularized random forest machine learning model; or
an adaptive boosting machine learning model.

15. The system of claim 13, wherein projecting the features of the second analytics data set onto the determined significant features of the first analytics data set comprises utilizing one or more of:
a Ridge Regression;
an Elastic Net Regression; or
a regularized random forest.

16. The system of claim 13, wherein the instructions, when executed by the at least one processor, further cause the system to generate a model reflecting an influence of the determined significant features on the analytics metric.

17. The system of claim 14, wherein the instructions, when executed by the at least one processor, cause the system to generate the model of the significance of the features of the second analytics data set relative to the analytics metric by substituting the correlation between the features of the second analytics data set and each significant feature for the significant features of the first analytics data set in the model reflecting the influence of the determined significant features on the analytics metric.

18. The system of claim 13, wherein the instructions, when executed by the at least one processor, further cause the system to generate projected weights indicting a projected influence of the features of the second analytics data set on the analytics metric.

19. The system of claim 18, wherein the instructions, when executed by the at least one processor, further cause the system to determine projected significant features of the second analytics data set relative to the analytics metric using the projected weights.

20. The system of claim 13, wherein the instructions, when executed by the at least one processor, further cause the system to generate the analytics insight for the second analytics data set relative to the analytics metric by:
determining probabilities of users of performing one or more actions leading to the analytics metric; and
identifying segments of users with high probabilities to target in a campaign directed to the analytics metric.
